(19) United States
(12) Patent Application Publication
(10) Pub. No.: US 2025/0124533 A1
(43) Pub. Date: Apr. 17, 2025

(54) BOARDING PLACE SETTING DEVICE, VEHICLE DISPATCH SERVICE SYSTEM, BOARDING PLACE SETTING METHOD, AND BOARDING PLACE DISPLAY DEVICE

(71) Applicants: Nissan Motor Co., Ltd., Kanagawa (JP); RENAULT S.A.S., Boulogne-Billancourt (FR)

(72) Inventors: Masayasu Suzuki, Kanagawa (JP); Shuyang Jia, Kanagawa (JP)

(73) Assignees: Nissan Motor Co., Ltd., Kanagawa (JP); RENAULT S.A.S., Boulogne-Billancourt (FR)

(21) Appl. No.: 18/551,518

(22) PCT Filed: Mar. 25, 2021
(86) PCT No.: PCT/IB2021/000191

§ 371 Date: Sep. 20, 2023

(51) Int. Cl. G06Q 50/47; G01C 21/34

(52) U.S. Cl. CPC G06Q 50/47; G01C 21/3438

(57) ABSTRACT

A vehicle dispatch service server (20) specifies a movement direction of a user based on position data of the user received from a user terminal (60). The vehicle dispatch service server (20) sets a boarding place from among one or more boarding place candidates that are present in a prescribed range around the user, and are present more toward the movement direction than the position of the user. The vehicle dispatch service server (20) transmits, to the user terminal (60), boarding place data including information on the set boarding place.

### TECHNICAL FIELD

The present invention relates to a boarding place setting device, a vehicle dispatch service system, a boarding place setting method, and a boarding place display device.

### BACKGROUND ART

Patent Literature 1 discloses a system for supporting transportation of passengers or items from one place to another place. In the system, a point close to a user is selected as a boarding place from among multiple points where the user can get on a vehicle and the selected boarding place is provided to a user terminal.

### CITATION LIST

### Patent Literature

[Patent Literature 1] Japanese Patent Application Publication No. 2018-526715

### SUMMARY OF THE INVENTION

### Problems to be Solved

According to the method disclosed in Patent Literature 1, even if the user understands the boarding place from information in the user terminal, the user may not be able to apprehend the direction to the boarding place well in the actual environment. In this case, it may take time for the user to arrive at the boarding place. Therefore, a vehicle dispatched to the user may have to stop and wait or drive around until the user arrives at the boarding place, and this may affect the surrounding traffic.

The present invention has been devised in consideration of the above problem, and an object of the present invention is to provide a boarding place setting device, a vehicle dispatch service system, a boarding place setting method, and a boarding place display device that can reduce the effect on the surrounding traffic.

### Solution to Problem

A boarding place setting device according to one aspect of the present invention specifies a movement direction of a user, based on position data of the user, that is received from the user terminal, sets a boarding place from among one or more boarding place candidates that are present in a prescribed range including surroundings of the user, and are present more toward the movement direction than a position of the user, and transmits, to the user terminal, boarding place data including information on the boarding place.

### Advantageous Effects

According to the present invention, the effect on the surrounding traffic can be reduced.

### BRIEF DESCRIPTION OF THE DRAWINGS

FIG. 1 is a diagram showing the configuration of a vehicle dispatch service system according to the present embodiment.

FIG. 2 is a block diagram showing the configuration of a vehicle dispatch service server shown in FIG. 1.

FIG. 3 is a block diagram showing the configuration of a vehicle shown in FIG. 1.

FIG. 4 is a block diagram showing the configuration of a user terminal shown in FIG. 1.

FIG. 5 is a sequence chart showing the flow of processing performed in the vehicle dispatch service system.

FIG. 6 is a flowchart showing the flow of processing performed by the vehicle dispatch service server.

FIG. 7 is a flowchart showing the flow of processing performed by the vehicle dispatch service server.

FIG. 8A is a diagram for explaining boarding place candidates that are present around a user.

FIG. 8B is a diagram for explaining the relationship between the user and the boarding place candidates.

FIG. 8C is a diagram for explaining the relationship between the user and the boarding place candidates.

FIG. 9A is an explanatory diagram showing information displayed on the user terminal.

FIG. 9B is an explanatory diagram showing information displayed on the user terminal.

FIG. 9C is an explanatory diagram showing information displayed on the user terminal.

### DESCRIPTION OF EMBODIMENTS

An embodiment of the present invention will be described below with reference to the accompanying drawings. In the illustration of the drawings, the same parts are denoted with the same reference numerals, and therefore the description thereof is omitted.

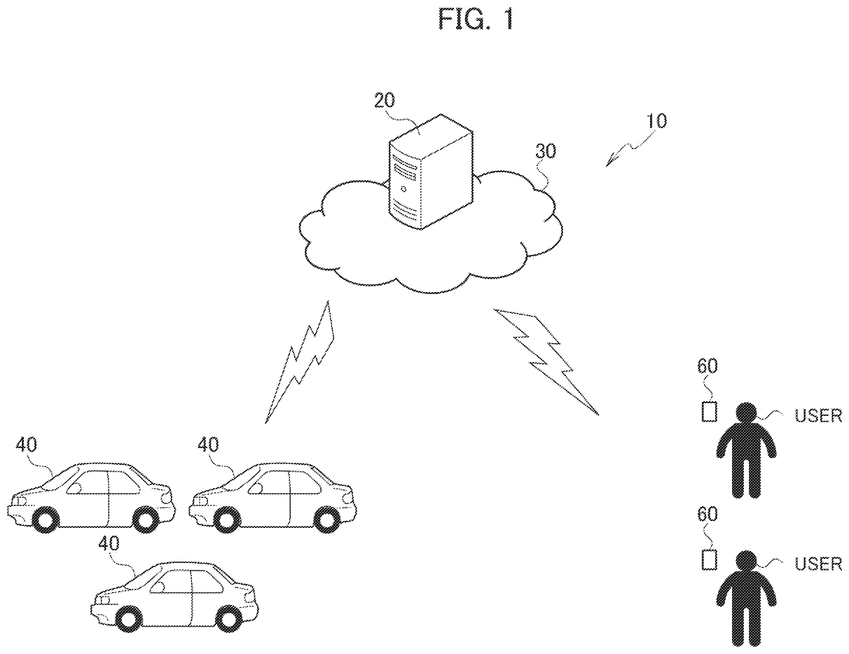

The configuration of a vehicle dispatch service system 10 according to the present embodiment will be described with reference to FIGS. 1 to 4. The vehicle dispatch service system 10 according to the present embodiment is a system for dispatching a vehicle 40 in response to a vehicle dispatch request from a user.

The vehicle dispatch service system 10 is mainly composed of a vehicle dispatch service server 20, a vehicle 40, and a user terminal 60. The vehicle dispatch service server 20, the vehicle 40, and the user terminal 60 are configured so as to be able to communicate with each other via a network 30. An example of the network 30 is the Internet. The network 30 may use mobile communication functions such as those of 4G/LTE or 5G.

In the following description, the term “vehicle dispatch request data” means data used by the user to perform a vehicle dispatch request to the vehicle dispatch service server 20. The vehicle dispatch request data includes information indicating the content of the vehicle dispatch request. Examples of the content of the vehicle dispatch request include the user's current position, the user's destination, and the like. In addition, examples of the content of the vehicle dispatch request may include a transit point on the way to the destination, a desired boarding time which is a time at which the user desires to get on the vehicle, and a desired alighting time which is a time at which the user desires to get off the vehicle.

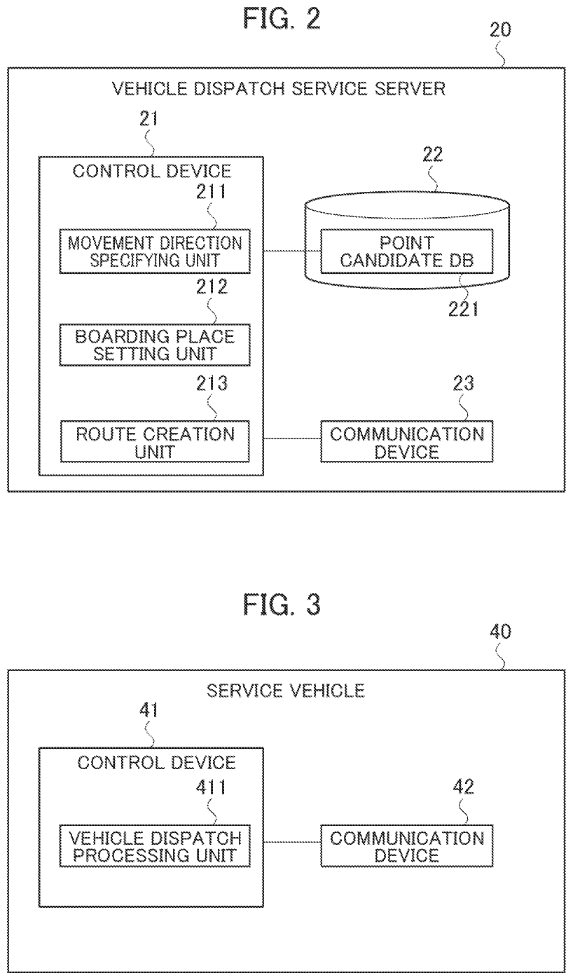

In FIG. 2, the vehicle dispatch service server 20 is operated by, for example, a business operator providing a transportation service using multiple vehicles 40, but the vehicle dispatch service server 20 is not limited thereto. The vehicle dispatch service server 20 is a device for dispatching a vehicle 40 to the user, and includes a control device 21, a storage device 22, and a communication device 23.

The control device 21 determines a vehicle dispatch plan based on the vehicle dispatch request data received by the communication device 23 from the user terminal 60. The vehicle dispatch plan includes setting a vehicle 40 to be dispatched to the user, setting a boarding place where the user gets on the vehicle 40, setting an alighting place where the user gets off the vehicle 40 at the destination, setting a travel route from the boarding place to the alighting place, setting the travel route for the vehicle 40 to travel to the alighting place, and the like.

As the control device 21, a microcomputer (controller) composed mainly of a CPU, a memory, and an input/output interface can be used. The CPU reads various computer programs stored in the memory or the like and executes various instructions included in the programs. By executing the programs, the CPU functions as multiple information processing circuits of the control device 21.

As one or more information processing circuits, the control device 21 includes a movement direction specifying unit 211, a boarding place setting unit 212, and a route creation unit 213. The movement direction specifying unit 211 specifies a movement direction in which the user moves, based on position data indicating the user's position received from the user terminal 60. The boarding place setting unit 212 sets a boarding place from among one or more boarding place candidates which are present around the user and are present more to the movement direction side than the user's position. The route creation unit 213 calculates a movement route for the user to move to the boarding place and calculates a travel route for the vehicle 40 to travel.

The storage device 22 is a storage unit that stores various databases necessary for the transportation service. The storage device 22 has a point candidate database (point candidate DB) 221.

In a service providing area for providing the transportation service using multiple vehicles 40, multiple points (hereinafter referred to as “designated points”) are prepared which are candidates for boarding places where users can get on vehicles 40 and candidates for alighting places where users can get off vehicles 40. The point candidate DB 221 manages point information for each designated point, the point information being information relating to the designated point. The point information includes information on the position of the designated point, information indicating whether the place is a boarding place or an alighting place or both, information indicating current availability, and the like.

In addition, the storage device 22 holds map data, which is data of a map including at least the service providing area, in order to create a route and recognize the positional relationship between the user and a vehicle 40. Further, for each vehicle 40, the storage device 22 may hold a vehicle DB that manages information on the vehicle 40, such as the current position of the vehicle 40, information on whether the vehicle 40 is empty, remaining energy (remaining fuel, remaining amount of charge), and the like.

The vehicle dispatch service server 20 includes the storage device 22, but the vehicle dispatch service server 20 may acquire the point information from an external data server by means of cloud computing without having the storage device 22.

The communication device 23 communicates with the vehicle 40 or the user terminal 60. The communication device 23 is controlled by the control device 21 and receives prescribed data from the vehicle 40 and the user terminal 60 or transmits prescribed data to the vehicle 40 and the user terminal 60. The communication device 23 can acquire road traffic data including road traffic information by communicating with an external device (not shown) via the network 30. For example, the communication device 23 may be a device with a mobile communication function such as those of 4G/LTE or 5G, or a device with a Wifi communication function.

In FIG. 3, the vehicle 40 is a vehicle (service vehicle) which the user gets on and which provides the transportation service, and the vehicle 40 is provided in plurality. In the example shown in FIG. 1, there are three vehicles 40, but the number of the vehicles 40 is not limited thereto. The vehicle 40 may be a vehicle that travels by means of an automatic driving function without a driver in the vehicle, or the vehicle 40 may be a vehicle that travels by means of manual driving performed by a driver. Further, the vehicle 40 may be a vehicle with a driver therein and which travels by means of an automatic driving function.

Automatic driving indicates a state in which, for example, at least one actuator out of actuators such as a brake, an accelerator, and a steering wheel is controlled without being operated by an occupant. Therefore, no problems are caused even if other actuators are operated by an occupant. Further, automatic driving may be a state in which any vehicle control such as acceleration/deceleration control and lateral position control is performed. Further, manual driving indicates, for example, a state in which a brake, an accelerator, and a steering wheel are operated by an occupant.

The vehicle 40 may be any one of a vehicle driven only by an engine, a hybrid vehicle driven by an engine and an electric motor, and an electric vehicle driven only by an electric motor.

In FIG. 3, the vehicle 40 has a control device 41 and a communication device 42.

The control device 41 controls the vehicle 40 based on route data including information on a travel route of the vehicle 40 received by the communication device 42 from the vehicle dispatch service server 20. As the control device 41, a microcomputer (controller) composed mainly of a CPU, a memory, and an input/output interface can be used. The CPU reads various computer programs stored in the memory or the like and executes various instructions included in the programs. By executing the programs, the CPU functions as multiple information processing circuits of the control device 41.

The control device 41 includes a vehicle dispatch processing unit 411 as one or more information processing circuits.

The vehicle dispatch processing unit 411 performs various types of processing based on the route data received from the vehicle dispatch service server 20. If the vehicle 40 travels by means of the automatic driving function, the vehicle dispatch processing unit 411 controls various actuators (a steering wheel actuator, an accelerator pedal actuator, a brake actuator, and the like) of the vehicle 40 based on the travel route data to perform automatic driving. The automatic driving performed by the vehicle dispatch processing unit 411 enables the vehicle 40 to travel automatically according to the travel route set by the vehicle dispatch service server 20. If the vehicle 40 travels by means of manual driving, the vehicle dispatch processing unit 411 controls a display device, a speaker, or the like and presents, to the driver, the travel route set by the vehicle dispatch service server 20.

The communication device 42 communicates with the vehicle dispatch service server 20. The communication device 42 is controlled by the control device 41, receives prescribed data from the vehicle dispatch service server 20, and transmits prescribed data to the vehicle dispatch service server 20. For example, the communication device 42 may be a device with a mobile communication function such as those of 4G/LTE or 5G, or a device with a Wifi communication function.

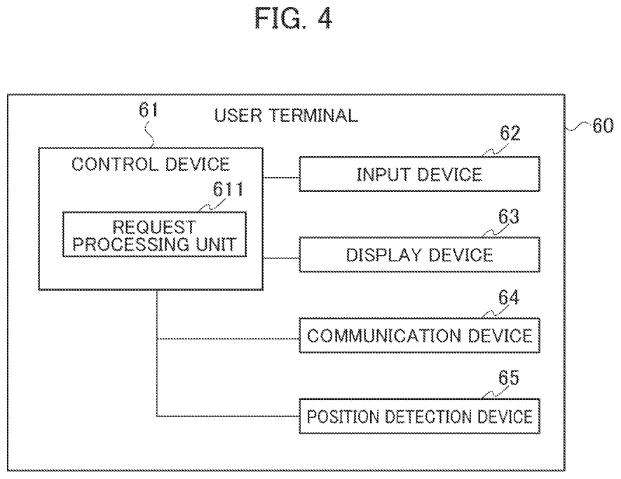

In FIG. 4, the user terminal 60 is a device that receives a user's vehicle dispatch request and displays information to the user. The user terminal 60 is an information terminal with communication functions that is a device that the user carries on a daily basis, such as a mobile phone, a smartphone, a personal digital assistant (PDA), or the like. FIG. 1 shows two user terminals 60, but the number of the user terminals 60 is not limited thereto.

The user terminal 60 includes a control device 61, an input device 62, a display device 63, a communication device 64, and a position detection device 65.

The control device 61 receives the user's vehicle dispatch request and generates vehicle dispatch request data. As the control device 61, a microcomputer (controller) composed mainly of a CPU, a memory, and an input/output interface can be used. In the memory, a computer program is installed to make the information terminal function as the user terminal 60 in the vehicle dispatch service system 10. By executing the computer program, the control device 61 functions as one or more information processing circuits of the user terminal 60.

The control device 61 includes a request processing unit 611 as one or more information processing circuits.

The request processing unit 611 generates vehicle dispatch request data corresponding to the vehicle dispatch request of the user. When requesting to dispatch a vehicle, the user operates the input device 62 to input the content of the vehicle dispatch request. An operation signal according to the user's input operation is input to the request processing unit 611 through the input device 62. Based on the operation signal and the like, the request processing unit 611 generates vehicle dispatch request data reflecting the content of the vehicle dispatch request and transmits the request data from the communication device 64 to the vehicle dispatch service server 20.

The request processing unit 611 controls the display device 63 based on the data received by the communication device 64 from the vehicle dispatch service server 20 and displays information included in the received data to the user. Further, the request processing unit 611 periodically acquires position data from the position detection device 65 and transmits the acquired position data from the communication device 64 to the vehicle dispatch service server 20.

The input device 62 is a device for the user to perform an input operation. The display device 63 is controlled by the request processing unit 611 and displays necessary information. For example, for the input device 62, a touch panel can be used which enables the user to perform input operations according to the information displayed on the display device 63.

The communication device 64 communicates with the vehicle dispatch service server 20. The communication device 64 is controlled by the control device 61, receives prescribed data from the vehicle dispatch service server 20, and transmits prescribed data to the vehicle dispatch service server 20. For example, the communication device 64 may be a device with a mobile communication function such as those of 4G/LTE or 5G, or a device with a Wifi communication function.

The position detection device 65 detects the position of the user terminal 60, that is, the user, and outputs position data indicating the user's position to the control device 61. The position detection device 65 detects the absolute position of the user and is composed of a GPS receiving unit for receiving a GPS signal, for example.

In addition to detecting the absolute position of the user, the position detection device 65 may detect the position of the user relative to the surrounding environment. For example, the position detection device 65 may be a device that can recognize the position of the user relative to the surrounding environment (for example, a building), such as a camera and an image analyzer, or a measurement device. Therefore, the position detection device 65 may be configured to output at least one of data indicating the absolute position of the user and data indicating the position of the user relative to the surrounding environment.

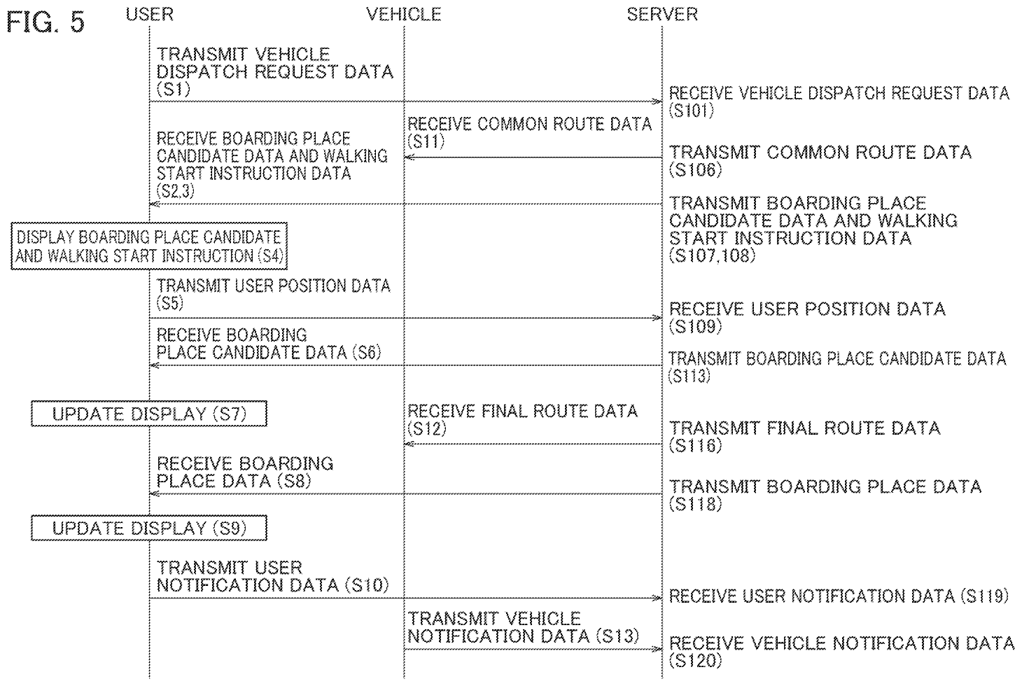

Hereinafter, with reference to FIGS. 5 to 7, a description will be given regarding the flow of the processing of the vehicle dispatch service system 10 according to the present embodiment, specifically, the flow of the processing for setting the boarding place where the user who has requested dispatch of a vehicle 40 gets on the vehicle 40 (boarding place setting method). The main entities of the processing performed by the vehicle dispatch service server 20, the vehicle 40, and the user terminal 60 are the control device 21, the control device 41, and the control device 61, respectively.

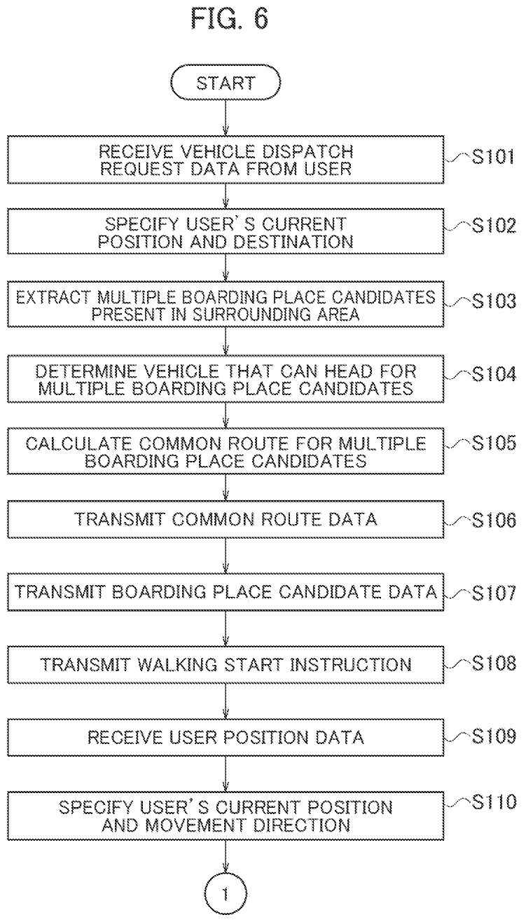

First, after the user terminal 60 generates vehicle dispatch request data in response to the vehicle dispatch request from the user, the user terminal 60 transmits the vehicle dispatch request data to the vehicle dispatch service server 20 (step S1 in FIG. 5). After receiving the vehicle dispatch request data (step S101 in FIGS. 5 and 6), the vehicle dispatch service server 20 specifies the user's current position and destination based on the vehicle dispatch request data (step S102 in FIG. 6).

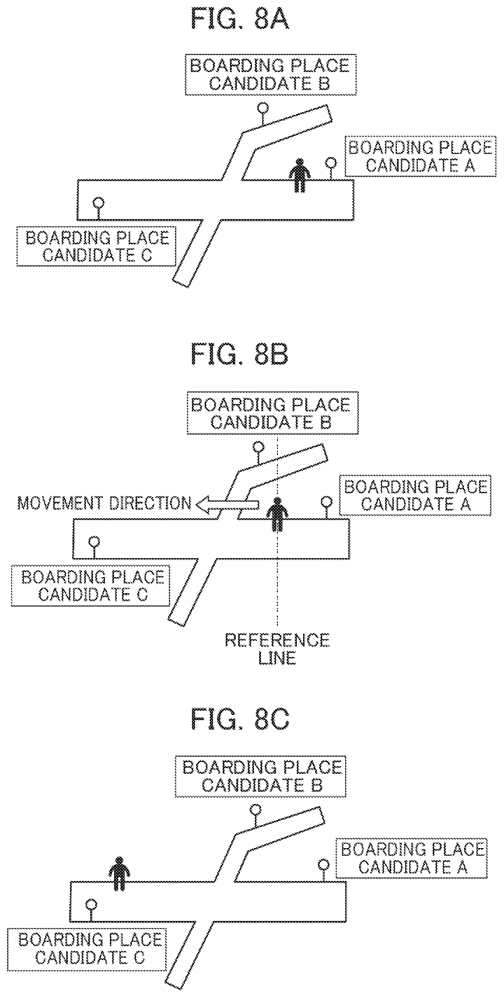

The vehicle dispatch service server 20 refers to the point candidate DB 221 and extracts multiple boarding place candidates for the user who has issued a vehicle dispatch request to get on the vehicle 40 (step S103 in FIG. 6). Considering that the user walks to the boarding place, the vehicle dispatch service server 20 sets multiple boarding place candidates in a prescribed range including the user's surrounding. For example, the vehicle dispatch service server 20 sets a circular range of which the radius is a prescribed distance (for example, 500 m) around the user's current position. The vehicle dispatch service server 20 extracts, as multiple boarding place candidates, multiple designated points that are present within the set range among the multiple designated points defined in the point candidate DB 221. Hereinafter, as shown in FIG. 8A, it is assumed that three boarding place candidates A, B, and C present around the user are extracted.

The vehicle dispatch service server 20 determines a vehicle 40 that can head for all of the three boarding place candidates A, B, and C, from among the multiple vehicles 40 providing the vehicle dispatch service (step S104 in FIG. 6).

In determining a vehicle 40, the vehicle dispatch service server 20 considers the situations of the multiple vehicles 40. Examples of the situation of a vehicle 40 include whether the distance from the current position of the vehicle 40 to each of the boarding place candidates A, B, and C is a determination distance or less, whether the remaining energy amount of the vehicle 40 is a determination energy amount or more, and whether the vehicle 40 is empty. The situation of a vehicle 40 may be acquired by the vehicle dispatch service server 20 communicating with the vehicle 40, or may be acquired from the vehicle DB if the storage device 22 holds the vehicle DB for managing the vehicles 40. Hereinafter, the vehicle 40 determined in this step is referred to as the “dispatched vehicle 40”.

The vehicle dispatch service server 20 calculates a common route for the three boarding place candidates A, B, and C (S105 in FIG. 6). The common route is a route that can be commonly used by the dispatched vehicle 40 to travel to the destination regardless of which of the three boarding place candidates A, B, and C the dispatched vehicle 40 heads toward. Therefore, the common route corresponds to a route in a section from the current position of the dispatched vehicle 40 to a final point of the common route, that is, a separation point at which the route separates from a route heading to another boarding place candidate to head toward any one of the boarding place candidates.

The vehicle dispatch service server 20 transmits the common route data including the information on the common route to the dispatched vehicle 40 (step S106 in FIGS. 5 and 6). Meanwhile, the dispatched vehicle 40 receives the common route data from the vehicle dispatch service server 20 (step S11 in FIG. 5). The dispatched vehicle 40 starts travelling with the reception of the common route data as a trigger and travels along the common route. If the dispatch vehicle 40 traveling on the common route is likely to arrive at the final point of the common route before receiving final route data, which will be described later, it is preferable for the dispatch vehicle 40 to wait at a waiting place in the vicinity of the final point.

Next, the vehicle dispatch service server 20 transmits boarding place candidate data and walking start instruction data to the user terminal 60 (steps S107 and S108 in FIGS. 5 and 6). The boarding place candidate data is data indicating three boarding place candidates A, B, and C that are present around the user, and is data for presenting the three boarding place candidates A, B, and C to the user by using the user terminal 60. Further, the walking start instruction data is data indicating a walking start instruction, which will be described later, and is data for presenting the walking start instruction to the user by using the user terminal 60.

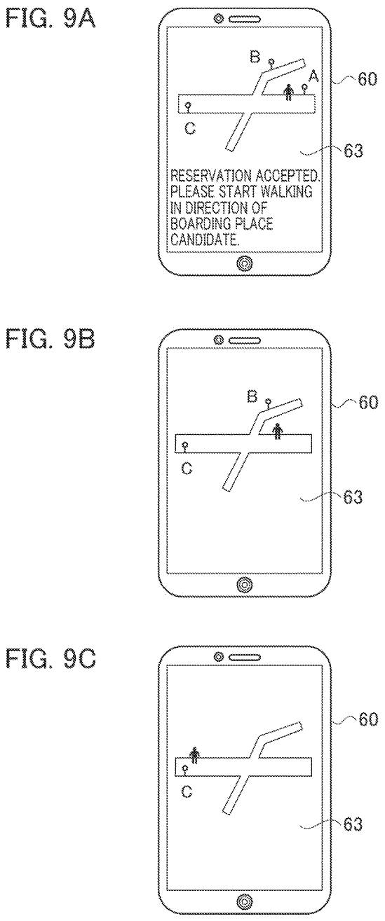

After the user terminal 60 receives the boarding place candidate data and walking start instruction data (steps S2 and S3 in FIG. 5), the user terminal 60 displays the three boarding place candidates A, B, and C on the display device 63 (step S4 in FIG. 5). As shown in FIG. 9A, the user terminal 60 displays a map of the user's surrounding area on the display device 63 and displays the user and the three boarding place candidates A, B, and C on the map in a superimposed manner. The user terminal 60 displays the user and the three boarding place candidates A, B, and C on the map in a superimposed manner such that positons correspond to the positions in real space.

Further, the user terminal 60 displays the walking start instruction on the display device 63 together with the three boarding place candidates A, B, and C (step S4 in FIG. 5). The walking start instruction is an instruction to prompt the user to move from the current position, and may be an instruction to the degree that the user is triggered to start moving. Further, the walking start instruction does not need to instruct the user to start walking toward one specific boarding place candidate A, B, or C, but may be an instruction to the degree that the user can start walking in some direction toward the boarding place candidates A, B, and C.

After the user terminal 60 starts displaying the content on the display device 63, the user terminal 60 updates the display content as necessary. For example, if the position of the user detected by the position detection device 65 changes, the user terminal 60 also changes the position of the user superimposed and displayed on the map, in accordance with the change in the position of the user.

After displaying the three boarding place candidates A, B, and C and the walking start instruction, the user terminal 60 starts detecting the user's position and transmits the user position data including the information on the user's position to the vehicle dispatch service server 20 (step S5 in FIG. 5). At step S5 and thereafter, the user terminal 60 periodically detects the position and transmits the user position data to the vehicle dispatch service server 20 each time. The user position data transmitted by the user terminal 60 is received by the vehicle dispatch service server 20 (step S109 in FIGS. 5 and 6).

The vehicle dispatch service server 20 specifies the current position and movement direction of the user based on the user position data (step S110 in FIG. 6). The movement direction can be specified from changes in the user's position over time.

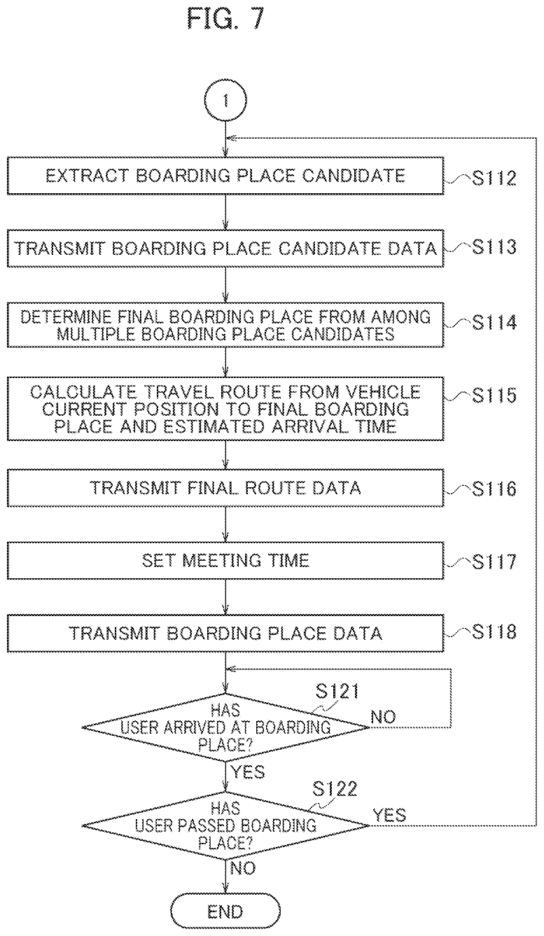

The vehicle dispatch service server 20 extracts, from the three boarding place candidates A, B, and C, a boarding place candidate that is present more to the movement direction side than the user's position (step S112 in FIG. 7). As shown in FIG. 8B, the vehicle dispatch service server 20 sets a reference line extending in a direction perpendicular to the movement direction to pass through the user, and extracts a boarding place candidate that is present more to the movement direction side than the reference line. That is, a boarding place candidate that is present within a range of 90 degrees to the left and right with the movement direction as the center is extracted. If there are multiple boarding place candidates on the movement direction side, the vehicle dispatch service server 20 extracts the multiple boarding place candidates. In an example shown in FIG. 8B, two boarding place candidates B and C are extracted out of the three boarding place candidates A, B, and C.

In the example shown in FIG. 8B, the vehicle dispatch service server 20 extracts the two boarding place candidates B and C that are present within a range of 90 degrees to the left and right with the movement direction as the center. However, the extraction may be performed for a limited range, such as a range of a prescribed angle (a prescribed angle<90 degrees) to the left and right with the movement direction as the center, or a range in which a certain distance from the user is the upper limit, rather than performing extraction for all ranges on the movement direction side.

The vehicle dispatch service server 20 transmits new boarding place candidate data to the user terminal 60 (step S113 in FIGS. 5 and 7). The new boarding place candidate data transmitted in this step is data for presenting the information of the two boarding place candidates B and C extracted in step S101 by using the user terminal 60.

After the user terminal 60 receives the boarding place candidate data (step S6 in FIG. 5), the user terminal 60 updates the display based on the received boarding place candidate data. As shown in FIG. 9B, the user terminal 60 displays the map of the user's surrounding area on the display device 63 and superimposes and displays the user and the two boarding place candidates B and C on the map. By updating the display by means of the new boarding place candidate data received after the user moves, the boarding place candidate A to the opposite side of the movement direction, among the three boarding place candidates A, B, and C originally displayed, is not displayed. That is, the new boarding place candidate data transmitted by the vehicle dispatch service server 20 in step S113 corresponds to control data for excluding the boarding place candidate A from being displayed.

Meanwhile, the vehicle dispatch service server 20 determines a final boarding place which is a final destination from among the multiple boarding place candidates B and C that are present on the movement direction side (step S114 in FIG. 5). The vehicle dispatch service server 20 uses one or more of the following first to third requirements to set a boarding place candidate that satisfies these requirements as the final boarding place.

### (First Requirement)

The vehicle dispatch service server 20 calculates the distance from the user's position to the boarding place candidates B and C for each boarding place candidate. The vehicle dispatch service server 20 then more preferentially sets a boarding place candidate with a short distance to the user's position as the final boarding place than a boarding place candidate with a long distance to the user's position. For example, in the example shown in FIG. 8B, the distance from the user's position to the boarding place candidate B is shorter than the distance from the user's position to the boarding place candidate C. In this case, the vehicle dispatch service server 20 sets the boarding place candidate B as the final boarding place.

### (Second Requirement)

The vehicle dispatch service server 20 calculates the degree of complexity of a movement route for the user to move from the current position to the boarding place candidates B and C for each boarding place candidate. The vehicle dispatch service server 20 then more preferentially sets a boarding place candidate in which the degree of complexity of the movement route is low as the final boarding place than a boarding place route in which the degree of complexity of the movement route is high. The degree of complexity of the movement route is determined in consideration of the number of right and left turns at intersections or to connecting roads, the number of times the user crosses the road, the road width, the degree of gradient, and the like. For example, in the example shown in FIG. 8B, the movement route toward the boarding place candidate B is a route that includes a right turn at the intersection. Meanwhile, the movement route from the user's position toward the boarding place candidate C is a route that extends straight along the road, which is less complicated than the movement route toward the boarding place candidate B. In this case, the vehicle dispatch service server 20 sets the boarding place candidate C as the final boarding place.

### (Third Requirement)

The vehicle dispatch service server 20 calculates, for each boarding place candidate, the time difference between the time required for the user to arrive at the boarding place candidates B and C and the time required for the dispatched vehicle 40 to arrive at the boarding place candidates B and C. Then, the vehicle dispatch service server 20 more preferentially sets a boarding place candidate with a smaller time difference as the final boarding place than a boarding place candidate with a larger time difference. For example, in the example shown in FIG. 8B, it is assumed that the time difference in the boarding place candidate B is five minutes and the time difference in the boarding place candidate C is ten minutes. In this case, the vehicle dispatch service server 20 sets the boarding place candidate B as the final boarding place.

If only one boarding place candidate is extracted in step S112, the boarding place candidate is set as the final boarding place without any further changes being made in this step.

After the final boarding place is set, the vehicle dispatch service server 20 calculates a travel route from the current position of the dispatched vehicle 40 to the final boarding place and an estimated arrival time at which the dispatched vehicle 40 will arrive at the final boarding place (step S115 in FIG. 7).

The vehicle dispatch service server 20 transmits final route data including information on the travel route to the dispatched vehicle 40 (step S116 in FIGS. 5 and 7). After the dispatched vehicle 40 receives the final route data from the vehicle dispatch service server 20 (step S12 in FIG. 5), the dispatched vehicle 40 overwrites the common route data with the final route data and travels along the newest travel route.

Meanwhile, the vehicle dispatch service server 20 sets a meeting time at which the user and the dispatched vehicle 40 will meet at the final boarding place (step S117 in FIG. 7). The vehicle dispatch service server 20 sets the meeting time in consideration of an estimated arrival time at which the user will arrive at the final boarding place from the user's current position and an estimated arrival time of the dispatched vehicle 40. For example, the above setting is performed such that the vehicle dispatch service server 20 compares the estimated arrival time of the user with the estimated arrival time of the dispatched vehicle 40 and sets the later time as the meeting time.

The vehicle dispatch service server 20 transmits boarding place data to the user terminal 60 (step S118 in FIGS. 5 and 7). The boarding place data is data for presenting information on the final boarding place by using the user terminal 60. The boarding place data includes information on the movement route to the final boarding place, the meeting time, and the like in addition to information on the final boarding place.

After the user terminal 60 receives the boarding place data (step S8 in FIG. 5), the user terminal 60 updates the display based on the received boarding place data (step S9 in FIG. 5). For example, as shown in FIG. 8C, it is assumed that the user moves to the vicinity of the boarding place candidate C and that the boarding place candidate C is set as the final boarding place. As shown in FIG. 9C, the user terminal 60 displays a map of the user's surrounding area on the display device 63 and superimposes and displays the user and the final boarding place C on the map. Therefore, by updating the display by means of the boarding place data, the boarding place candidate B, which does not correspond to the final boarding place, from among the two boarding place candidates B and C which have been displayed so far is not displayed. That is, the boarding place data transmitted by the vehicle dispatch service server 20 in step S118 corresponds to the control data for excluding the boarding place candidate B, which the user has passed without stopping, from being displayed. Moreover, the user terminal 60 can display information on the movement route to the final boarding place and the meeting time.

The user terminal 60 determines whether the user has arrived at the final boarding place from an input operation from the user or from a comparison result between the final boarding place and the user's position. If user terminal 60 determines that the user has arrived at the final boarding place, the user terminal 60 transmits user notification data for notifying the arrival of the user to the vehicle dispatch service server 20 (step S10 in FIG. 5). The user notification data transmitted by the user terminal 60 is received by the vehicle dispatch service server 20 (step S119 in FIG. 5).

The dispatched vehicle 40 determines whether the dispatched vehicle 40 has arrived at the final boarding place from an input operation from the driver or from a comparison result between the final boarding place and the position of the dispatched vehicle 40. If the dispatched vehicle 40 determines that the dispatched vehicle 40 has arrived at the final boarding place, the dispatched vehicle 40 transmits vehicle notification data for notifying the arrival of the dispatched vehicle 40 to the vehicle dispatch service server 20 (step S13 in FIG. 5). The vehicle notification data transmitted by the dispatched vehicle 40 is received by the vehicle dispatch service server 20 (step S120 in FIG. 5).

After the vehicle dispatch service server 20 determines that the user has arrived at the final boarding place based on the user notification data (YES in step S121 in FIG. 7), the vehicle dispatch service server 20 determines whether the user has passed the final boarding place (step S122 in FIG. 7).

If the user has passed the final boarding place (YES in step S122 of FIG. 7), the vehicle dispatch service server 20 transmits, to the user terminal 60, control data for excluding the final boarding place that the user has passed from being displayed.

The processing returns to step S112, and the vehicle dispatch service server 20 extracts a boarding place candidate that is present more to the movement direction side than the user's position among multiple boarding place candidates that are present around the user. Then, the vehicle dispatch service server 20 performs the processing at step S113 and thereafter.

In this way, in the present embodiment, the vehicle dispatch service server 20 specifies the movement direction in which the user moves, based on the position data of the user, and sets the boarding place from among one or more boarding place candidates that are present more to the movement direction side than the user's position.

According to this configuration, when the user moves, the boarding place is set more to the movement direction side than the user's position, and therefore the user can head toward the boarding place without being aware of the direction to the boarding place in the actual environment. Since the user can smoothly arrive at the boarding place, the dispatched vehicle 40 and the user can meet in a timely manner. This can suppress the effect that the dispatched vehicle 40 has on the surrounding traffic.

In the present embodiment, the vehicle dispatch service server 20 transmits instruction data for prompting the user to move from the current position to the user terminal 60, and thereafter specifies the movement direction. According to this configuration, since it is possible to prompt the user to move, it is possible to avoid the user remaining at that position. Accordingly, it is possible to appropriately specify the movement direction and set the boarding place smoothly.

In the present embodiment, the position data includes at least one of data indicating the absolute position of the user and data indicating the position of the user relative to the surrounding environment. According to this configuration, the movement direction can be appropriately specified. Further, since it is possible to use the position of the user relative to the surrounding environment, the movement direction can be recognized without using the absolute position of the user.

In the present embodiment, the vehicle dispatch service server 20 more preferentially sets a boarding place candidate with a short distance to the user's position as a boarding place than a boarding place candidate with a long distance to the user's position. According to this configuration, it is possible to set a boarding place at which is easy for the user to arrive. This can suppress a delay in the user's arrival at the boarding place, and therefore the user can meet the dispatched vehicle 40 in a timely manner.

In the present embodiment, the vehicle dispatch service server 20 more preferentially sets a boarding place candidate where the degree of complexity of the movement route is small as a boarding place than a boarding place route where the degree of complexity of the movement route is large. According to this configuration, since it is possible to set a boarding place at which is easy for the user to arrive, the dispatched vehicle 40 and the user can meet in a timely manner.

In the present embodiment, the vehicle dispatch service server 20 more preferentially sets a boarding place candidate where the arrival time difference between the user and the dispatched vehicle 40 is small as a boarding place than a boarding place candidate where the arrival time difference is large. According to this configuration, it is possible to set a boarding place candidate where the user and the vehicle can efficiently meet as the boarding place. Since the vehicle dispatched to the user has less time to wait for the user, it is possible to suppress the effect that the vehicle has on the surrounding traffic.

In the present embodiment, the vehicle dispatch service server 20 refers to the point candidate DB 221 that holds information on multiple points at which the user can get on the vehicle 40, and extracts multiple boarding place candidates that are present in a prescribed range around the user. Then, the vehicle dispatch service server 20 sets the boarding place from among one or more of the extracted multiple boarding place candidates which are present more to the movement direction side than the user's position. According to this configuration, by referring to the database, the boarding place candidates can be extracted as data processing.

In the present embodiment, the vehicle dispatch service server 20 transmits the boarding place candidate data to the user terminal 60 until the vehicle dispatch service server 20 specifies the movement direction, and the boarding place candidate data is for causing the user terminal to present multiple boarding place candidates that are present in the prescribed range around the user. Further, after specifying the movement direction, the vehicle dispatch service server 20 transmits the control data to the user terminal 60, and the control data is for excluding boarding place candidates that are present to the opposite side of the movement direction from being presented.

This configuration enables the user to recognize multiple boarding place candidates around the user. This eliminates the necessity for the user to head for one boarding place candidate, and therefore the user does not need to start walking while being aware of a specific direction. Further, due to the presence of multiple boarding place candidates, it is possible to prompt the user to move in some direction. Furthermore, after the movement direction is specified, one or more boarding place candidates that are present more to the movement direction side than the user's position are presented on the user terminal, and boarding place candidates that are present to the opposite side of the movement direction are excluded from being presented. As a result, it is possible to suppress the situation in which the user is confused about which direction to head toward by continuously presenting, on the user terminal, boarding place candidates that are present to the opposite side of the movement direction.

In the present embodiment, the vehicle dispatch service server 20 transmits, to the user terminal 60, control data for excluding boarding places that the user has passed from being presented. According to this configuration, since boarding places that the user has passed are no longer presented, it is possible to suppress wasteful actions such as the user being unsure about which direction to take due to being influenced by boarding places that he or she has passed, and the user going back down the same road again from which he or she has come.

In the present embodiment, until the boarding place is set, the vehicle dispatch service server 20 sets a common travel route used for heading to multiple boarding place candidates within a prescribed range around the user, as a travel route of the dispatched vehicle 40. Meanwhile, after the boarding place is set, the vehicle dispatch service server 20 sets the travel route from the current position of the dispatched vehicle 40 to the boarding place as the travel route of the dispatched vehicle 40. According to this configuration, the vehicle can travel along a travel route from which the vehicle can head toward any of the multiple boarding place candidates before the boarding place is set. With this configuration, there is no need for the vehicle to wait to travel or drive around until the boarding place is set, and this can suppress the effect on traffic.

Further, in the vehicle dispatch service system and the boarding place setting method presented in the present embodiment, similar to the vehicle dispatch service server 20 (boarding place setting device), the user can arrive at the boarding place smoothly, and therefore the dispatched vehicle 40 and the user can meet in a timely manner, and this can suppress the effect that the dispatched vehicle 40 has on the surrounding traffic.

In addition, the user terminal 60 presented in the present embodiment functions as the boarding place display device for displaying the boarding place candidate data and walking start instruction data to the user. This boarding place display device enables the user to arrive at the boarding place smoothly, and therefore the dispatched vehicle 40 and the user can meet in a timely manner, and this can suppress the effect that the dispatched vehicle 40 has on the surrounding traffic.

In the above embodiment, the boarding place is not presented in advance to the user, and the boarding place is set and presented after the user's movement direction is specified. However, the presentation content of the present embodiment may be applied to a method in which the user's movement direction is specified after the boarding place is presented in advance to the user, and then the boarding place is set and presented again.

Further, in the present embodiment, the vehicle dispatch service server 20 is realized as a device for dispatching the vehicle 40 to the user. However, the vehicle dispatch service server 20 may be realized as a device for generating data for dispatching the vehicle 40 to the user, or may provide, to the user, data generated by a server of a business operator providing a transportation service.

Further, in the present embodiment, a display method is exemplified as a method for presenting information by using the user terminal 60, but a method other than the display method may be used, such as a presentation method using audio or the like.

The present embodiment presents an example in which software implements multiple information processing circuits of the control devices 21, 41, and 61. However, it is also possible to configure the information processing circuits by preparing dedicated hardware for executing the function of each information processing circuit. Further, the multiple information processing circuits may be constituted by individual hardware.

Although an embodiment of the present invention has been described as above, the discussion and drawings forming part of this disclosure should not be construed as limiting the invention. Various alternative embodiments, examples, and operational techniques will be apparent to those skilled in the art from this disclosure.

### REFERENCE SIGNS LIST

10 Vehicle dispatch service system
20 Vehicle dispatch service server (boarding place setting device)
21 Control device
22 Storage device
221 Point candidate DB
23 Communication device
40 Vehicle (dispatched vehicle)
41 Control device
42 Communication device
60 User terminal (boarding place display device)
61 Control device
62 Input device
63 Display device
64 Communication device
65 Position detection device

1. A boarding place setting device comprising:
a communication device that transmits and receives data to and from a user terminal that presents information to a user who has requested to dispatch a vehicle; and
a controller that controls the communication device and sets a boarding place where the user gets on the vehicle,
wherein the controller:
specifies a movement direction in which the user moves, from changes in a position of the user over time based on position data that is received from the user terminal and includes information on a position of the user,
sets the boarding place from among one or more boarding place candidates that are present in a prescribed range including surroundings of the user, and are present more toward the movement direction than the position of the user, and
transmits, to the user terminal, boarding place data for causing the user terminal to present information on the boarding place.

2. The boarding place setting device according to claim 1, wherein the controller:
transmits, to the user terminal, instruction data for causing the user terminal to present an instruction for prompting the user to move from a current position, and
after the instruction data is transmitted to the user terminal, specifies the movement direction.

3. The boarding place setting device according to claim 1, wherein the position data includes at least one of data indicating an absolute position of the user and data indicating a position of the user relative to a surrounding environment.

4. The boarding place setting device according to claim 1, wherein the controller:
calculates, for each boarding place candidate, a distance from the user to the boarding place candidate, and
preferentially sets a boarding place candidate with a short distance to the user as the boarding place over a boarding place candidate with a long distance to the user.

5. The boarding place setting device according to claim 1, wherein the controller:
calculates, for each boarding place candidate, a degree of complexity of a movement route from the user to the boarding place candidate, and
preferentially sets a boarding place candidate in which the degree of complexity of the movement route is low as the boarding place over a boarding place in which the degree of complexity of the movement route is high.

6. The boarding place setting device according to claim 1, wherein the controller:
calculates, for each boarding place candidate, a time difference between a time required for the user to arrive at the boarding place candidate and a time required for the vehicle to arrive at the boarding place candidate, and
preferentially sets a boarding place candidate in which the time difference is small as the boarding place over a boarding place candidate in which the time difference is large.

7. The boarding place setting device according to claim 1, wherein the controller:
refers to a database that holds information on a plurality of points at which the user can get on the vehicle and extracts a plurality of boarding place candidates that are present in the prescribed range, and
sets the boarding place from among one or more boarding place candidates that are present more toward the movement direction than the position of the user, from among the extracted plurality of boarding place candidates.

8. The boarding place setting device according to claim 7, wherein the controller:
transmits, to the user terminal until the movement direction is specified, boarding place candidate data for causing the user terminal to present the plurality of boarding place candidates that are present in the prescribed range, and
transmits, to the user terminal after the movement direction is specified, control data for excluding a boarding place candidate that is present in a direction opposite to the movement direction from being presented.

9. The boarding place setting device according to claim 1, wherein the controller determines whether the user has passed the boarding place, and when having determined that the user has passed the boarding place, transmits, to the user terminal, control data for excluding the boarding place that the user has passed from being presented.

10. The boarding place setting device according to claim 7, wherein the controller:
sets a common travel route until the boarding place is set that enables the vehicle to head toward the plurality of boarding place candidates that are present in the prescribed range as a travel route of the vehicle, and
sets a travel route from a current position of the vehicle to the boarding place as a travel route of the vehicle after the boarding place is set.

11. A vehicle dispatch service system comprising:
a user terminal that presents information to a user who has requested to dispatch a vehicle; and
a vehicle dispatch service server that dispatches the vehicle to the user,
wherein the vehicle dispatch service server includes:
a communication device that transmits and receives data to and from the user terminal; and
a controller that controls the communication device and sets a boarding place where the user gets on the vehicle, and
wherein the controller:
specifies a movement direction in which the user moves, from changes in a position of the user over time based on position data that is received from the user terminal and includes information on a position of the user,
sets the boarding place from among one or more boarding place candidates that are present in a prescribed range including surroundings of the user and are present more toward the movement direction than the position of the user, and
transmits, to the user terminal, boarding place data for causing the user terminal to present information on the boarding place.

12. A boarding place setting method comprising:
transmitting and receiving data to and from a user terminal that presents information to a user who has requested to dispatch a vehicle, and setting a boarding place where the user gets on the vehicle,
wherein a controller that processes the data:
specifies a movement direction in which the user moves, from changes in a position of the user over time based on position data that is received from the user terminal and includes information on a position of the user,
sets the boarding place from among one or more boarding place candidates that are present in a prescribed range including surroundings of the user, and are present more toward the movement direction than the position of the user, and
transmits, to the user terminal, boarding place data for causing the user terminal to present information on the boarding place.

13. A boarding place display device comprising:
a communication device that transmits and receives data to and from a server that generates boarding place candidate data indicating a boarding place candidate for a user to get on a vehicle from changes in a position of the user over time based on information on a position of the user;
a display device that displays data transmitted from the server; and
a detection device that detects position data including information on a position of the user,
wherein the communication device transmits the position data detected by the detection device to the server, and receives the boarding place candidate data and walking start instruction data indicating an instruction for prompting the user to move, which are transmitted from the server, and
wherein the display device displays the received boarding place candidate data and the received walking start instruction data to the user.
